(19) United States
(12) Patent Application Publication
(10) Pub. No.: US 2026/0189527 A1
(43) Pub. Date: Jul. 2, 2026

(54) INFORMATION PROCESSING SYSTEM, INFORMATION PROCESSING APPARATUS, AND INFORMATION PROCESSING METHOD

(71) Applicant: Atsuo SHIMADA, Kanagawa (JP)

(72) Inventor: Atsuo SHIMADA, Kanagawa (JP)

(21) Appl. No.: 19/387,703

(22) Filed: Nov. 13, 2025

(30) Foreign Application Priority Data
Dec. 27, 2024 (JP) 2024-231708

(51) Int. Cl. H04L 51/02; G06F 3/0482

(52) U.S. Cl. CPC H04L 51/02; G06F 3/0482

(57) ABSTRACT

An information processing system includes: circuitry that activates one or more interactive artificial intelligences (AIs) that interact with a user; and a memory that stores, for each of one or more messages previously received, the message and information for identifying the interactive AI that has responded to the message in association, and the circuitry receives an input of a first message from the user; determines an interactive AI configured to respond to the first message based on a relevance between the first message and the one or more messages stored in the memory; and displays, on a display, a response generated by the interactive AI that is determined in response to the first message.

### CROSS-REFERENCE TO RELATED APPLICATIONS

This patent application is based on and claims priority pursuit to 35 U.S.C. § 119 (a) to Japanese Patent Application No. 2024-231708, filed on Dec. 27, 2024, in the Japan Patent Office, the entire disclosure of which is hereunder incorporated by reference herein.

### BACKGROUND

### Technical Field

The present disclosure relates to an information processing system, an information processing apparatus, and an information processing method.

### Related Art

The background computer system automatically generates a response to a message such as a question from a user, and outputs the response to have a conversation with the user.

For example, for each of a plurality of bots, a bot capability catalog representing the capabilities of the bot in natural language is matched with a user service prompt represented in natural language. One or more bots are selected based on the matching result.

### SUMMARY

The present disclosure described herein provides an information processing system including circuitry that activates one or more interactive artificial intelligences (AIs) that interact with a user, and a memory that stores, for each of one or more messages previously received, the message and information for identifying the interactive AI that has responded to the message in association. The circuitry receives an input of a first message from the user, determines an interactive AI configured to respond to the first message based on a relevance between the first message and the one or more messages stored in the memory, and displays, on a display, a response generated by the interactive AI that is determined in response to the first message.

The present disclosure described herein provides an information processing apparatus configured to activate one or more interactive AIs that interact with a user, the information processing apparatus including circuitry that: receives an input of a first message from the user; determines an interactive AI configured to respond to the first message based on a relevance between the first message and one or more messages stored in a memory, the memory storing, for each of the one or more messages previously received, the message and information for identifying the interactive AI that has responded to the message in association; and displays, on a display, a response generated by the interactive AI that is determined in response to the first message.

The present disclosure described herein provides an information processing method performed by a computer that activates one or more interactive AIs that interact with a user, the information processing method including: receiving an input of a first message from the user; determining an interactive AI configured to respond to the first message based on a relevance between the first message and one or more messages stored in a memory, the memory storing, for each of the one or more messages previously received, the message and information for identifying the interactive AI that has responded to the message in association; and displaying, on a display, a response generated by the interactive AI that is determined in response to the first message.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a diagram illustrating an example of a configuration of an information processing system according to a first embodiment;

FIG. 2 is a diagram illustrating an example of a hardware configuration of an information processing apparatus according to the first embodiment;

FIG. 3 is a diagram illustrating an example of a functional configuration of the information processing system according to the first embodiment;

FIG. 4 is a sequence diagram illustrating an example of a process to determine a responding agent according to the first embodiment;

FIG. 5 is a diagram illustrating an example of an interactive screen at the start of conversation;

FIG. 6 is a table of an example of a user information storage unit;

FIG. 7 is a table of an example of a history information storage unit;

FIG. 8 is a diagram illustrating a first example of an interactive screen based on a determination result indicating an agent candidate;

FIG. 9 is a diagram illustrating a second example of an interactive screen based on a determination result indicating an agent candidate;

FIG. 10 is a sequence diagram illustrating an example of a process to determine a responding agent according to the first embodiment;

FIG. 11 is a diagram illustrating an example of an interactive screen that displays a response in the first embodiment;

FIG. 12 is a diagram illustrating an example of an interactive screen based on a determination result of an agent candidate for the second time or later in the first embodiment;

FIG. 13 is a sequence diagram illustrating an example of a process to determine a responding agent according to the second embodiment;

FIG. 14 is a sequence diagram illustrating an example of a process to determine a responding agent according to the third embodiment;

FIG. 15 is a diagram illustrating an example of an interactive screen that displays a response in the first to third embodiments; and

FIG. 16 is a diagram illustrating an example of an interactive screen that displays a response for the second time or later, following the interactive screen of FIG. 15.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

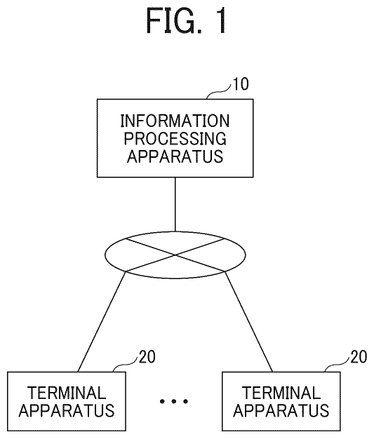

FIG. 1 is a diagram illustrating an example of a configuration of an information processing system according to a first embodiment. In FIG. 1, one or more terminal apparatuses 20 are connected to an information processing apparatus 10 via a network such as a local area network (LAN) or the Internet.

The information processing apparatus 10 is implemented by one or more computers that operate a plurality of types of interactive artificial intelligence (AI), which is an AI system designed for a two-way communication with a user. The interactive AI is an anthropomorphic, virtual existence that appears to the user as a conversation partner. In the interaction with the interactive AI, which is the conversation partner, the user inputs a message and the interactive AI outputs a response. Specifically, the interactive AI receives a message input by the user from the terminal apparatus 20. The interactive AI searches for document data having a relatively high similarity to the message from a set of document data previously registered in the information processing apparatus 10. The interactive AI controls generation of a response to the message based on the searched document data, and outputs the response to the terminal apparatus 20. The message input by the user may be a question, an instruction, a request, or any other input information that requires a response. The response is text that includes information corresponding to the message. Alternatively, the response may be output by voice. For simplicity, the interactive AI is referred to as an “agent” in the present embodiment. Alternatively, the interactive AI may be referred to as an AI agent, a digital clone, a personalized AI, an AI assistant, an auto-response AI, a communication partner, a conversation partner, an AI chatbot, a companion, a concierge, or a virtual interactive interface. The agent may be a virtual human displayed on the screen of the terminal apparatus 20 as a conversation partner, for example, in the form of a three-dimensional (3D) avatar imitating a person.

In the present embodiment, various types of agents are available, and the agents are different in terms of the data source that the agent refers to when generating the response to the message from the user. In other words, the agents are associated with the data sources that are different form one another. The data source is a set or a collection of document data. For example, the data sources are sets of document data related to different fields. The agents search the corresponding data sources that are different from one another using the same message, for particular document data related to the message. Since the response corresponding to the message is generated based on the searched document data, the agents generate responses that are different from one another in response to the same message.

The information processing apparatus 10 selects, from among the agents, an agent suitable for generating the message from the user as a generation source of the response. In other words, the information processing apparatus 10 determines the agent to be the conversation partner of the user. The information processing apparatus 10 may further determine that the agent suitable for generating the message from the user should be changed as the conversation proceeds, and automatically switch the agent to be the conversation partner.

The terminal apparatus 20 is a device that operates as a user interface of the information processing system. For example, the terminal apparatus 20 may be implemented by a personal computer (PC), a smartphone, or a tablet terminal. For example, the terminal apparatus 20 includes a CPU, a memory, a communication circuit such as a network interface circuit, and a display. The terminal apparatus 20 receives an input of a message from the user and transmits the message to the information processing apparatus 10. The terminal apparatus 20 also receives a response generated in response to the message from the information processing apparatus 10 and displays the response. The terminal apparatus 20 may output the received information, for example, through a projector.

In the present embodiment, it is assumed that the information processing system is operated by a certain company, which may be referred to as “company X”. The user who can access the information processing apparatus 10 is a person belonging to the company X, such as an employee of the company X. The service provided by the information processing apparatus 10 may be open to the public as a cloud service.

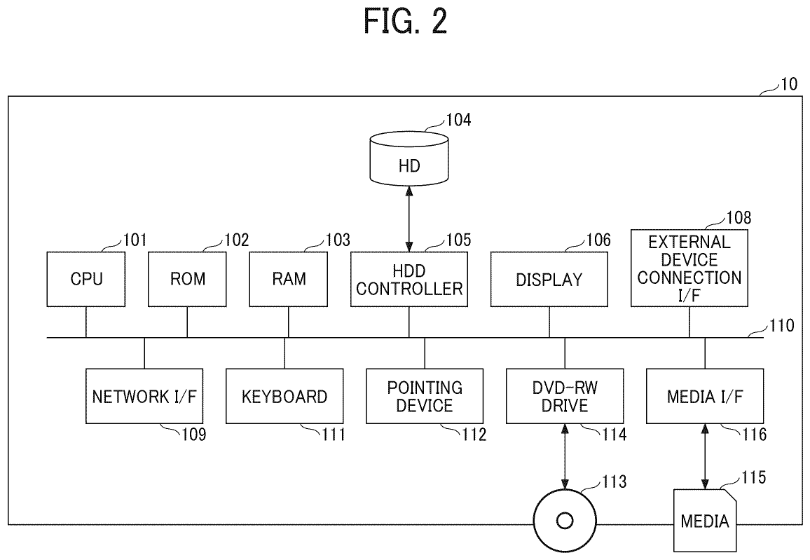

FIG. 2 is a diagram illustrating an example of a hardware configuration of the information processing apparatus 10 according to the first embodiment. As illustrated in FIG. 2, the information processing apparatus 10 is implemented by a computer, which includes a central processing unit (CPU) 101, a read-only memory (ROM) 102, a random-access memory (RAM) 103, a hard disk (HD) 104, a hard disk drive (HDD) controller 105, a display 106, an external device connection interface (I/F) 108, a network I/F 109, a data bus 110, a keyboard 111, a pointing device 112, a digital versatile disk rewritable (DVD-RW) drive 114, and a media I/F 116.

The CPU 101 controls the overall operation of the information processing apparatus 10. The ROM 102 stores a program such as an initial program loader (IPL) to boot the CPU 101. The RAM 103 is used as a work area for the CPU 101. The HD 104 stores various data such as a program. The HDD controller 105 controls reading or writing of various types of information from or to the CPU 101 under the control of the HD 104. The display 106 displays various information such as a cursor, a menu, a window, text, or an image. The external device connection I/F 108 is an interface circuit that connects with various external devices. Examples of the external devices include, but are not limited to, a universal serial bus (USB) memory and a printer. The network I/F 109 is an interface circuit that controls communication of data with various external devices through a communication network. Examples of the data bus 110 include, but not limited to, an address bus and a data bus, which electrically connects the components such as the CPU 501 with one another.

The keyboard 111 is an example of an input device provided with a plurality of keys for allowing the user to enter characters, numerical values, or various instructions. The pointing device 112 is another example of the input device that allows the user to select or execute a specific instruction, select a target for processing, or move a cursor being displayed. The DVD-RW drive 114 reads and writes various data from and to a DVD-RW 113, which is an example of a removable storage medium. The removable storage medium is not limited to the DVD-RW and may be, for example, a digital versatile disc recordable (DVD-R). The media I/F 116 controls reading and writing (storing) of data from and to a storage medium 115 such as a flash memory.

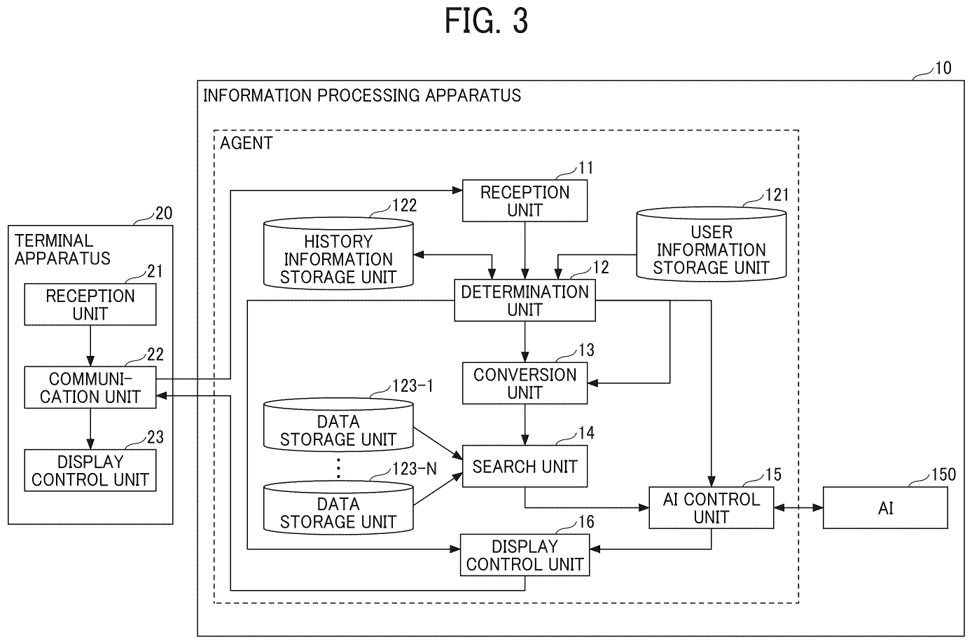

FIG. 3 is a diagram illustrating an example of a functional configuration of the information processing system 10 according to the first embodiment. In FIG. 3, the information processing apparatus 10 provides an AI 150 and an agent.

The AI 150 is a machine-learning model (for example, a neural network), which has been trained to generate a text in response to an input text when the text is input. The text being generated may be referred to as a response, and the input text may be referred to as a prompt. The AI 150 may be learned so as to output a response including, for example, an image or a file. For example, the AI 150 generates, as a response to the prompt, text having the highest occurrence probability based on the learning result. The AI 150 may be a generative AI based on a large language model (LLM). The LLM is a machine learning model that has learned natural language processing using a large amount of text data. The LLM is used in many natural language processing (NLP) tasks, such as generating responses to specific questions, automatically generating sentences, summarizing text, translating, and analyzing emotions. Further, the LLM may be used in various fields such as education, entertainment, customer service, and product development. In the present embodiment, the prompt is the text including the message input by the user. The AI 124 may be a machine-learning model other than the LLM. The AI 150 does not have to be operated on the information processing apparatus 10.

For example, the AI 150 may be the generative AI that is open to the public, such as the one available on the Internet.

In the present disclosure, the machine learning is defined as a technology that makes a computer to acquire human-like learning ability. In addition, the machine learning refers to a technology in which a computer autonomously generates an algorithm required for determination such as data identification from learning data loaded in advance and applies the generated algorithm to new data to make a prediction. Any suitable learning method is used in machine learning. For example, any one of supervised learning, unsupervised learning, semi-supervised learning, reinforcement learning, and deep learning, or a combination of two or more of those learning methods may be used.

The agent is an example of the interactive AI as described above. The agent is a set of functional units, which receives a message from the user and generates a response to the message, for example, using Retrieval Augmented Generation (RAG). Specifically, the agent includes, as the functional units, a reception unit 11, a determination unit 12, a conversion unit 13, a search unit 14, an AI control unit 15, and a display control unit 16. These units are implemented by the CPU 101 that execute processes according to one or more programs installed on the information processing apparatus 10. The agent uses a user information storage unit 121, a history information storage unit 122, and a plurality of data storage units 123-1 to 123-N. These storage units are each implemented by, for example, the HD 104 or a storage device that can be connected to the information processing apparatus 10 via the network.

In the present embodiment, the information processing apparatus 10 operates as a plurality of types of agents, but the actual program that operates as each agent is common between the agents. As described above, the agents are made different based on the data source to be referred to when generating the response.

The reception unit 11 receives inputs from the user. For example, the reception unit 11 receives a message from the user. More specifically, the user input is performed on the terminal apparatus 20.

The reception unit 11 thus receives information corresponding to the input, which is received by the terminal apparatus 20, from the terminal apparatus 20.

The determination unit 12 determines one or more agents, as agent candidates, each being a candidate to generate a response to the message received by the reception unit 11. The determination unit 12 refers to the history information storage unit 122 and the user information storage unit 121 to determine the agent candidates. The determination unit 12 determines an agent that generates a response from among the agent candidates.

In other words, the determination unit 12 determines the agent that generates the response to the message received by the reception unit 11.

The history information storage unit 122 stores messages received in the past, information for identifying agents that have responded to the messages, and attribute information of users who have input the messages, in association with one another.

The determination unit 12 determines one or more agent candidates for a first message, which is the message received by the reception unit 11, based on the relevance between the first message and each message stored in the history information storage unit 122. In the present embodiment, the similarity between the messages is an example of the relevance between the messages. The determination unit 12 further determines an agent candidate for the first message based on the similarity between the attribute information of the user related to the first message and the attribute information stored in the history information storage unit 122. The attribute information of the user related to the first message may be acquired from the user information storage unit 121.

The determination unit 12 allows the user to select, from among the agent candidates, an agent that generates the response. The agent that generates the response is referred to as a responding agent.

The user information storage unit 121 stores attribute information for each user of the information processing system.

When the reception unit 11 receives a message, the conversion unit 13 converts the message into a vector, which may be referred to as a “semantic vector” and expresses the meaning of the message by a multi-dimensional numerical value. The semantic vector may be generated using the natural language processing such as BERT. The semantic vector generated by converting the message is referred to as a “message vector”.

The search unit 14 extracts a part of document data having a relatively high relevancy to the message, from among the document data stored in the data storage unit 123 corresponding to the responding agent, using the message vector generated by the conversion unit 13. The data storage unit 123 to be searched by the search unit 14, which is a storage from which the document data is acquired, differs depending on the responding agent.

Each data storage unit 123 previously stores the document data related to various tasks of the company X. The set of document data stored in each data storage unit 123 differs.

Specifically, the document data to be acquired differs depending on the role of the agent. Accordingly, each data storage unit 123 may be implemented by a database provided for each agent. Alternatively, a part or all of the data storage units 123 used by two or more agents may be implemented by the same database. The document data may be registered in the data storage unit 123 in a batch, or uploaded to the data storage unit 123 at any time according to user operation. The data storage unit 123 stores, for each document data registered in the data storage unit 123, the document data and a semantic vector of each chunk of the document data. The chunk of the document data refers to a part of the document data obtained by dividing the document data in a predetermined unit. The dividing unit of the document data may be defined by the number of characters, the number of sentences, or a semantic unit (for example, a paragraph). The chunks of the document data may be stored in advance, after the document data is divided in units. The semantic vector of each chunk may be referred to as a “chunk vector”. The search unit 14 calculates, for each document data in the data storage unit 123 to be searched, the similarity between the message vector and the chunk vector of each chunk of the document data. The search unit 14 further specifies a chunk corresponding to a chunk vector having the highest similarity to the document data, as a “similar chunk”. The search unit 14 compares the similarities of the similar chunks for each document data and extracts the top M similar chunks having the highest similarities. As a result, the M pieces of document data are selected. To evaluate the similarity between the vectors, a cosine similarity may be used, or another index may be used. The search unit 14 includes, in the search result, related document information including the top M similar chunks, chunk IDs stored in the data storage unit 123 in association with the similar chunks, and document IDs and file names (“document names”) stored in the data storage unit 123 in association with the document data to which the similar chunks belong. The data storage unit 123 may be managed based on a folder, a database, or any other management unit of document data.

The AI control unit 15 transmits, to the AI 150, a prompt, which is an instruction to generate a response. The prompt includes the message received by the reception unit 11 and a set of similar chunks related to the search result by the search unit 14. The AI control unit 15 receives the response generated by the AI 150 from the AI 150.

The display control unit 16 causes the terminal apparatus 20 to display information indicating the one or more agent candidates, which are determined by the determination unit 12, in a manner that are selectable by the user. The display control unit 16 also causes the terminal apparatus 20 to display a response generated by the agent that the user selects as the responding agent. Specifically, the display control unit 16 transmits, to the terminal apparatus 20, display data such that a display screen is displayed on the terminal apparatus 20.

The terminal apparatus 20 includes a reception unit 21, a communication unit 22, and a display control unit 23. These units are implemented by the CPU of the terminal apparatus 20 that execute processes according to the program installed on the terminal apparatus 20.

The reception unit 21 receives an operation performed by the user on the terminal apparatus 20.

The communication unit 22 controls communication with the information processing apparatus 10.

The display control unit 23 controls display of screens such as an interactive screen 510 using a browser, based on information received from the information processing apparatus 10 such as display data.

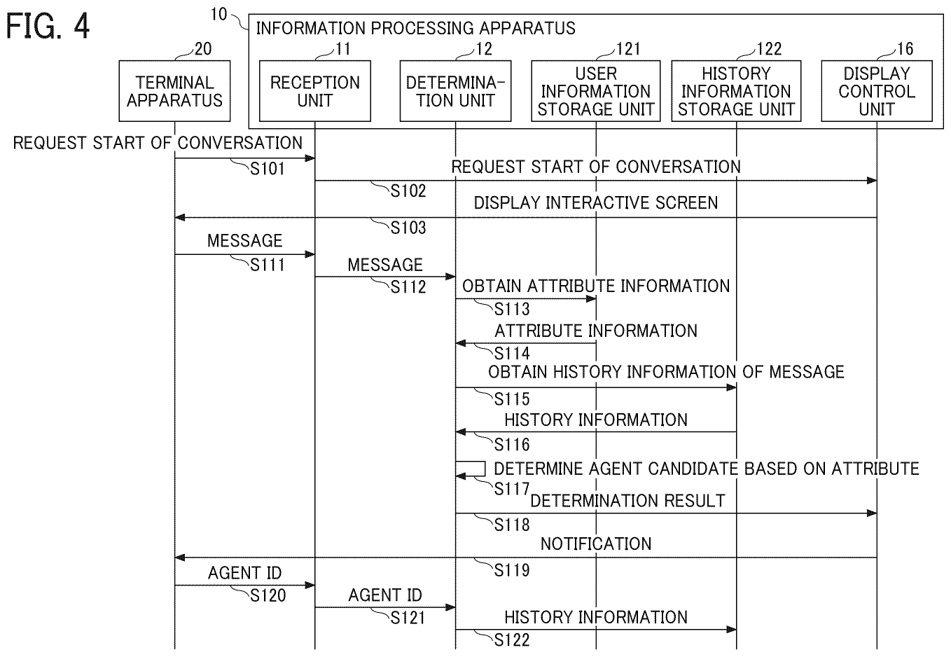

The processes performed by the information processing system will be described below. FIG. 4 is a sequence diagram illustrating an example of a process to determine a responding agent according to the first embodiment. At the start of the process of FIG. 4, it is assumed that the user of the terminal apparatus 20, who is referred to as the subject user, has logged in to the information processing apparatus 10 after being authenticated by the information processing apparatus 10. In other words, the user ID of the subject user is stored in, for example, the RAM 103 as the user ID of the login user.

When the subject user inputs an instruction to start a conversation to the terminal apparatus 20, at S101, the terminal apparatus 20 transmits a request to start a conversation to the information processing apparatus 10. At S102, the reception unit 11 of the information processing apparatus 10 sends a notification indicating a request to start the conversation to the display control unit 16. In response to the request to start, at S103, the display control unit 16 causes the terminal apparatus 20 to display an interactive screen, which is a screen for receiving an input of a message from the user and interacting between the user and the agent. Specifically, the display control unit 16 generates display data of the interactive screen, and transmits the display data to the terminal apparatus 20 to display the interactive screen on the display for the terminal apparatus 20.

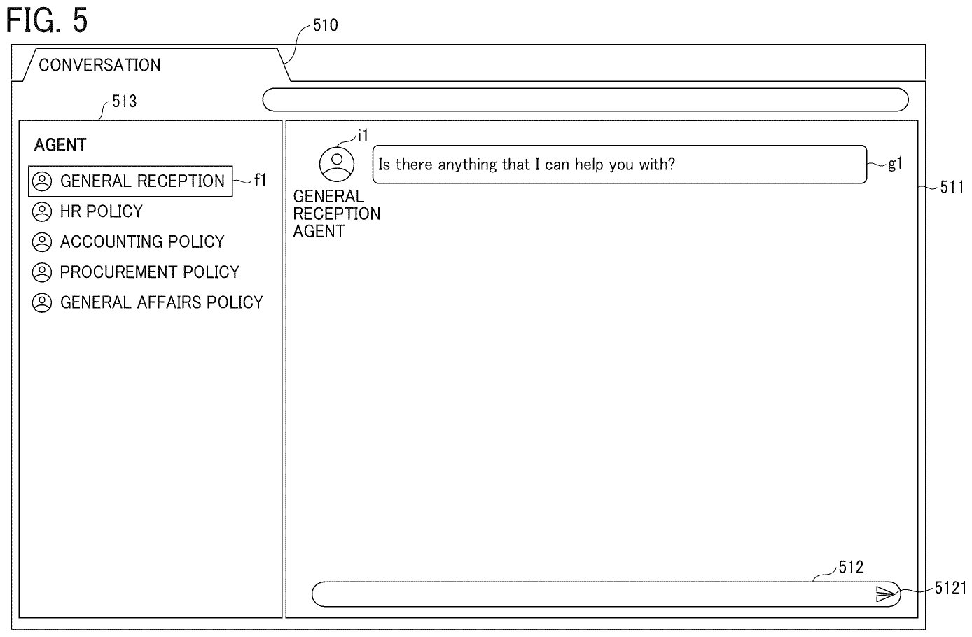

FIG. 5 is a diagram illustrating an example of an interaction screen displayed at the start of conversation. The interactive screen 510 illustrated in FIG. 5 includes an interactive display area 511, a message input area 512, and an agent list display area 513. The interactive display area 511 is an area in which the contents of the conversation between the agent and the user is displayed. In the initial state, the interactive display area 511 displays a greeting sentence g1 “Is there anything that I can help you with?” to request the user to input a message. An icon i1 representing the agent is displayed on the left of the greeting sentence g1. In the interactive screen 510 at the start of the conversation, the responding agent is not determined. The greeting sentence g1 initially displayed is assumed to be a greeting sentence from a general reception agent. The general reception agent interacts with the user until the responding agent is determined.

The message input area 512 is an area for receiving an input of a message from the user, and includes a send icon 5121. The agent list display area 513 is an area in which the names (“agent names”) of all of the plurality of types of agents are displayed in the form of a list. When one agent is selected from among the plurality of agents displayed in the agent list display area 513, the display control unit 16 may switch the screen to an interactive screen, which allows the user to interact with the selected agent. FIG. 5 illustrates an example case in which an agent is provided for each type of policy in the company X, such as “human resources (HR) policy”, “accounting policy”, “procurement policy”, and “general affairs policy”, in addition to the “general reception” agent. The “HR policy” is a set of document data describing, for example, a payment rule of a service, handling of a working time and a travel time at the time of a business trip, and a special rule when traveling abroad. The “accounting policy” is a set of document data describing, for example, travel expense settlement, handling of receipts, and exchange rate calculation. The “procurement policy” is a set of document data describing, for example, payment procedures when obtaining a passport, and a flow to approve the purchase. The “general affairs policy” is a set of document data describing, for example, operation management of a business office, a use rule of a company car, emergency response, and safety management. Each agent corresponding to a specific one of these policies interacts with the user as an expert regarding a set of document data corresponding to each of the policies including “HR policy”, “accounting policy”, “procurement policy”, and “general affairs policy”. The agent list display area 513 indicates the agent, which is the current conversation partner, by a frame line f1. In FIG. 5, since the general reception agent is the conversation partner, the “general reception” is surrounded by the frame line f1.

When the user inputs a message in the message input area 512 and clicks the send icon 5121, at S111, the terminal apparatus 20 transmits the message, which is referred to as the subject message, to the information processing apparatus 10.

When the reception unit 11 receives the subject message, at S112, the reception unit 11 inputs the subject message to the determination unit 12. The determination unit 12 performs the process to select the agent candidate based on the subject message at S113 to S117.

At S113 and S114, the determination unit 12 acquires the attribution information corresponding to the user ID of the subject user from the user information storage unit 121.

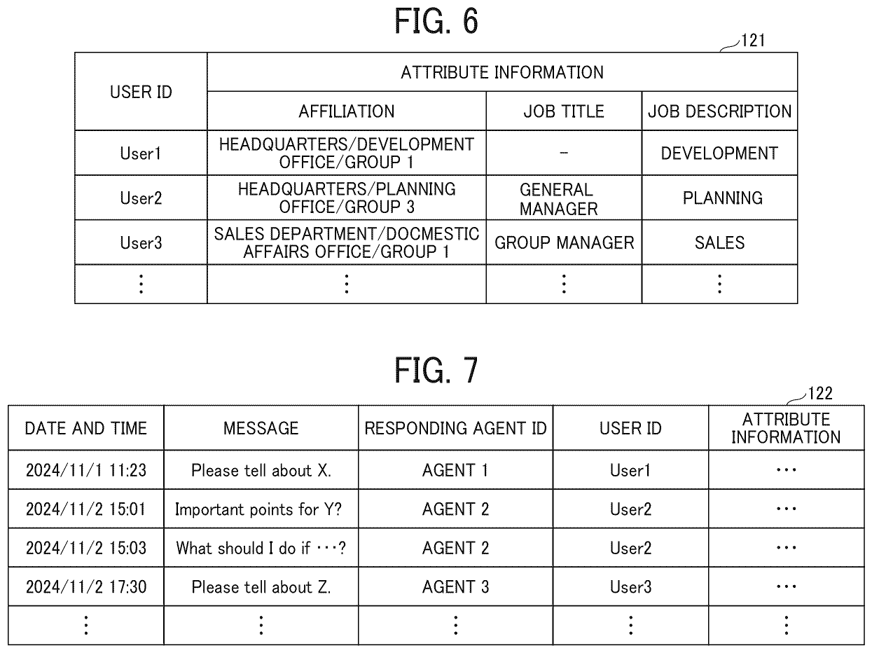

FIG. 6 is a table illustrating an example of the user information storage unit 121. The user information storage unit 121 illustrated in FIG. 6 stores, for each user, the attribute information of the user in association with the user ID of the user. The attribute information is information indicating the attribute and characteristics of each user. In the example of FIG. 6, the attribute information includes items of affiliation, job title, and job description. The affiliation indicates an organization, such as a department, to which the user belongs in the company X. The job title indicates the job title of the user. The job description indicates the job description of the user. The attribute information is used to determine an agent candidate corresponding to the subject message. The agent candidate is an agent that is likely to have necessary knowledge with respect to the subject message. It is desirable that the items of the attribute information are selected so that the attribute information is common among users who have common knowledge in performing job duties, but different among users who have different knowledge in performing job duties. For simplicity, the knowledge in performing job duties is referred to as the job knowledge. This is based on assumption that the messages input to the agent are similar among the users having common job knowledge.

The attribution information of the subject user acquired at S114 may be referred to as “subject attribution information”.

At S115 and S116, the determination unit 12 acquires a part of history information having relatively high relevance to the subject message from the history information storage unit 122.

FIG. 7 is a table of an example of the history information storage unit 122. The history information storage unit 122 illustrated in FIG. 7 stores history information including a date and time, a message, a responding agent ID, a user ID, and attribute information, for each message received from the user in the past.

The date and time is the date and time when the history information is recorded, and is substantially the same as the date and time when the message is received. The message is the contents of the message input by the user. The responding agent ID, which may be referred to as an “agent ID”, is identification information of an agent that has responded to the message.

The user ID is a user ID of the user who has input the message. The attribute information is attribute information of the user, such as the affiliation, the job title, and the job description of the user. The attribute information may change due to personnel changes. The attribute information recorded as a part of the history information is the attribute information of the user obtained at the time indicated by the date and time of the history information.

A part of the history information including a message having a relatively high similarity to the subject message is an example of a part of the history information having a relatively high relevance to the subject message. The degree of similarity between the subject message and the message included in the history information may be evaluated, for example, using an index based on any desired technique of comparing character strings. Alternatively, the subject message and the message included in the history information may each be converted into a semantic vector. The similarity between these vectors, such as cosine similarity, may be calculated as an index indicating the degree of similarity. The determination unit 12 acquires a part of the history information having a high similarity to the subject message. In one example, the determination unit 12 may obtain a predetermined number of history information from the top in the order, as the part of the history information. Alternatively, the determination unit 12 may obtain the history information having the index indicating the similarity, which is higher than a threshold, as the part of the history information. The history information acquired at S116 may be referred to as “extracted history information”.

At S117, the determination unit 12 selects the agent IDs of one or more agent candidates, which are referred to as the “agent candidate IDs”, from among the agent IDs included in the extracted history information, based on the subject attribute information. For example, the determination unit 12 selects, as the agent candidate IDs, the agent IDs of one or more records of history information each including the attribute information having a relatively high similarity to the subject attribute information, from among the extracted history information. Specifically, when the attribute information has a relatively large number of items having the same value as that of the subject attribute information, the determination unit 12 determines that the attribute information has a relatively high similarity to the subject attribute information. Alternatively, the determination unit 12 may specify, as the agent candidate ID, the agent ID of the attribute information in which the values of all items are the same as those of the items included in the subject attribute information. When the number of records of the extracted history information is equal to or less than a predetermined number, the determination unit 12 may specify, as the agent candidate IDs, the agent IDs of all records of the extracted history information. On the other hand, when the number of the extracted history information exceeds the predetermined number, the determination unit 12 may select the predetermined number of records of history information, from among the extracted history information. As described above, at S117, the determination unit 12 may not perform any selection. If no selection is performed at S117, the determination unit 12 determines, as the agent candidate IDs, the agent IDs of all records of the extracted history information.

At S118, the determination unit 12 inputs the determination result including the agent candidates IDs of the one or more specified agents, to the display control unit 16. At S119, the display control unit 16 causes the interactive screen 510 to display a notification based on the determination result. Specifically, the display control unit 16 generates display data based on the notification and transmits the display data to the terminal apparatus 20 for display of the notification.

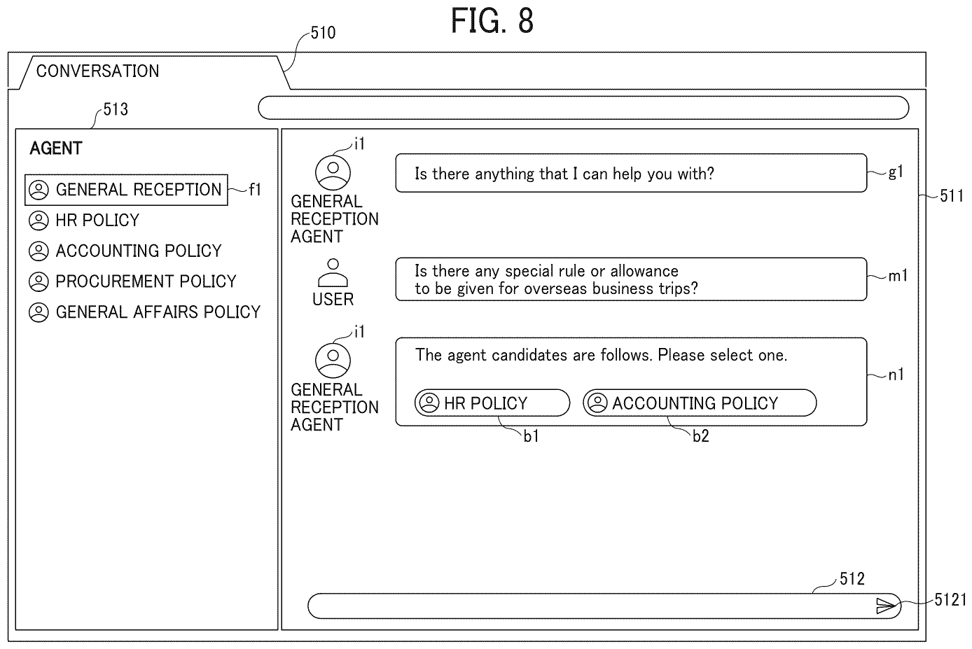

FIG. 8 is a diagram illustrating a first example of an interactive screen displayed based on the determination result indicating the agent candidate. In FIG. 8, the same elements as those in FIG. 5 are denoted by the same reference numerals, and descriptions thereof will be omitted. In the interactive screen 510 illustrated in FIG. 8, a message m1 and a notice n1 are added.

The message m1 is the subject message that the user has input in the message input area 512 at S111. When the user clicks a send icon 5121, the subject message input in the message input area 512 is displayed in the interactive display area 511.

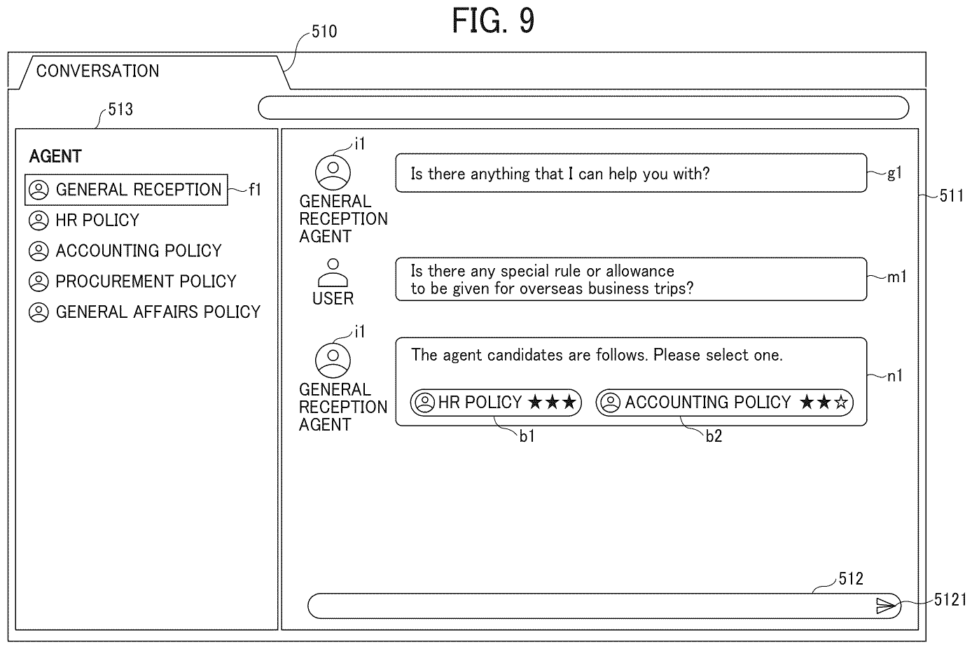

The notice n1 is a display content additionally displayed at S119. The notice n1 is a notice, which requests the user to select any one of the agent candidates as a responding agent, and includes a button corresponding to each agent candidate. In FIG. 8, for the message m1 “Is there any special rule or allowance to be given for overseas business trips?”, two agents including the “HR policy” agent and the “accounting policy” agent are displayed as agent candidates. The notice n1 includes a button b1 corresponding to the “HR policy” agent, and a button b2 corresponding to the “accounting policy” agent. The notice n1 may contain the display content illustrated in FIG. 9.

FIG. 9 is a diagram illustrating a second example of an interactive screen displayed based on the determination result indicating the agent candidate. In FIG. 9, the same elements as those in FIG. 8 are denoted by the same reference numerals, and descriptions thereof will be omitted.

In FIG. 9, stars are additionally displayed for each button in the notice n1. The star mark may represent an evaluation of similarity between the subject message and the history information. The star mark may alternatively represent an evaluation value, which is the degree of recommendation, based on the evaluation of similarity between the subject attribute information and the attribute information of the extracted history information. For example, the evaluation value is used when the extracted history information is acquired at S115 and S116, or when the agent candidate ID is specified from the agent IDs of the extracted history information based on the subject attribute information at S117. The higher these similarities, the higher the number of stars. The user may select a responding agent based on the number of starts.

When the user selects one of the button b1 and the button b2, at S120, the terminal apparatus 20 transmits the agent ID of the agent corresponding to the selected button, which may be referred to as the “selected agent ID”, to the information processing apparatus 10. When the reception unit 11 of the information processing apparatus 10 receives the selected agent ID, at S121, the reception unit 11 inputs the selected agent ID to the determination unit 12. The determination unit 12 determines the selected agent ID as the agent ID of the responding agent. At S122, the determination unit 12 records the history information for the subject message in the history information storage unit 122 (FIG. 7). More specifically, the current date and time, the subject message, the selected agent ID, the user ID of the subject user, and the attribute information of the subject user are input to the “date and time”, the “message”, the “responding agent ID”, the “user ID”, and the “attribute information” of the history information, respectively.

Subsequently, the operation proceeds to a process of generating a response to the subject message.

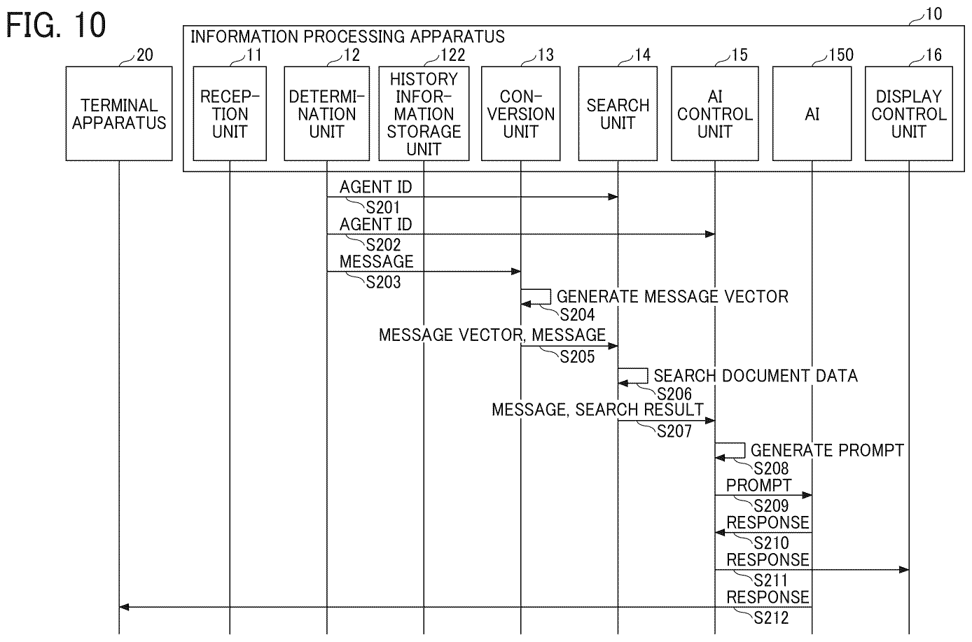

FIG. 10 is a sequence diagram illustrating an example of a process to determine a responding agent according to the first embodiment.

At S201 and S202 following S122 of FIG. 4, the determination unit 12 sets the selected agent ID in each of the search unit 14 and the AI control unit 15. Such setting is performed to associate the behavior of the search unit 14 and the AI control unit 15 with the agent (responding agent) identified with the selected agent ID.

At S203, the determination unit 12 inputs the subject message to the conversion unit 13. At S204, the conversion unit 13 converts the subject message, which is input, into a semantic vector to generate a message vector. At S205, the conversion unit 13 inputs the message vector, which may be referred to as the “subject message vector”, and the target message to the search unit 14.

At S206, the search unit 14 searches the data storage unit 123 corresponding to the selected agent ID set at S201, using the subject message vector, to obtain a search result. The data storage unit 123 corresponding to the selected agent ID is the data storage unit 123 corresponding to the responding agent. Specifically, the search unit 14 compares the chunk vector and the message vector stored for each document data and for each chunk in the data storage unit 123 corresponding to the selected agent ID, specifies the similar chunks for each document data, and extracts one or more similar chunks having relatively high similarity to the subject message. The search unit 14 generates, for each of the extracted similar chunks, information including the related document information of the similar chunk as a search result. At S207, the search unit 14 inputs the subject message and the search result to the AI control unit 15.

At S208, the AI control unit 15 generates a prompt by entering the search result and the subject message to a system prompt. The system prompt is a template of a prompt to be input to the AI 150, and is prepared in advance. The following is an example of the system prompt.

### Example of System Prompt Begins

The message from the user is as follows.
{Message} Please generate a response to the message by referring to the following document.
{Set of similar chunks related to search result}

### Example of System Prompt Ends

In this case, the AI control unit 15 generates a prompt by entering the subject message to the {message} portion of the system prompt, and entering the set of similar chunks related to the search result by the search unit 14 to the {set of similar chunks related to search result} portion of the system prompt. By inputting the prompt generated in this manner to the AI 150, the AI 150 generates a response by using even the information included in the set of similar chunks related to the search result, which includes information that the AI 150 has not learned. Accordingly, the response from the AI 150 may be based on a set of similar chunks associated with the search result.

The system prompt may be prepared for each agent. Further, the system prompts may be different between agents. In this case, the AI control unit 15 may generate a prompt by entering the subject message and the search result to the system prompt, which corresponds to the selected agent ID set at S202.

At S209, the AI control unit 15 transmits the generated prompt to the AI 150. At S210, the AI control unit 15 receives, from the AI 150, a response generated by the AI 150 to which the prompt is input. At S211, the AI control unit 15 inputs the response, which may be referred to as the “subject response”, to the display control unit 16. At S212, the display control unit 16 displays the subject response on the interactive screen 510 displayed on the terminal apparatus 20. Specifically, the display control unit 16 generates display data based on the subject response, and transmits the display data to the terminal apparatus 20 for display of the subject response.

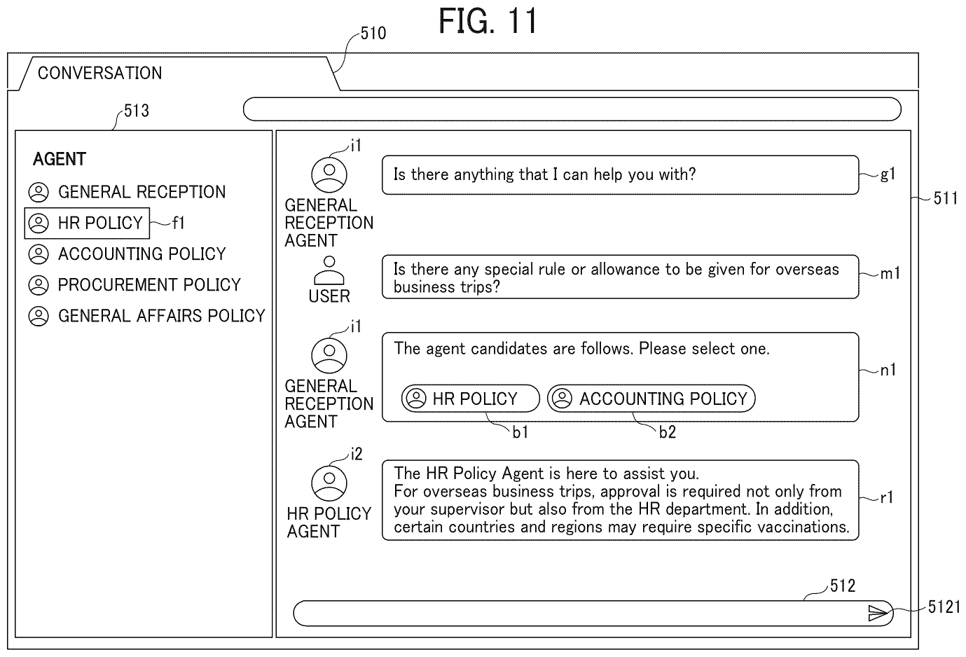

FIG. 11 is a diagram illustrating an example of an interactive screen that displays a response in the first embodiment. In FIG. 11, the same elements as those in FIG. 8 are denoted by the same reference numerals, and descriptions thereof will be omitted. An icon i2 and a response r1 are added to the interactive screen 510 illustrated in FIG. 11.

The response r1 is a response from the agent to the message m1. FIG. 11 illustrates the example case in which the “HR policy” agent is selected. The response from the “HR policy” agent, which is a response based on the “HR policy”, is displayed as the response r1.

The icon i2 represents the “HR policy” agent. The entity represented by the icon i2 is actually different from that of the icon i1.

In FIG. 11, the “HR policy” in the agent list display area 513 is surrounded by a frame line f1. The presence of the frame line f1 indicates that the current conversation partner has been changed to the “HR policy” agent.

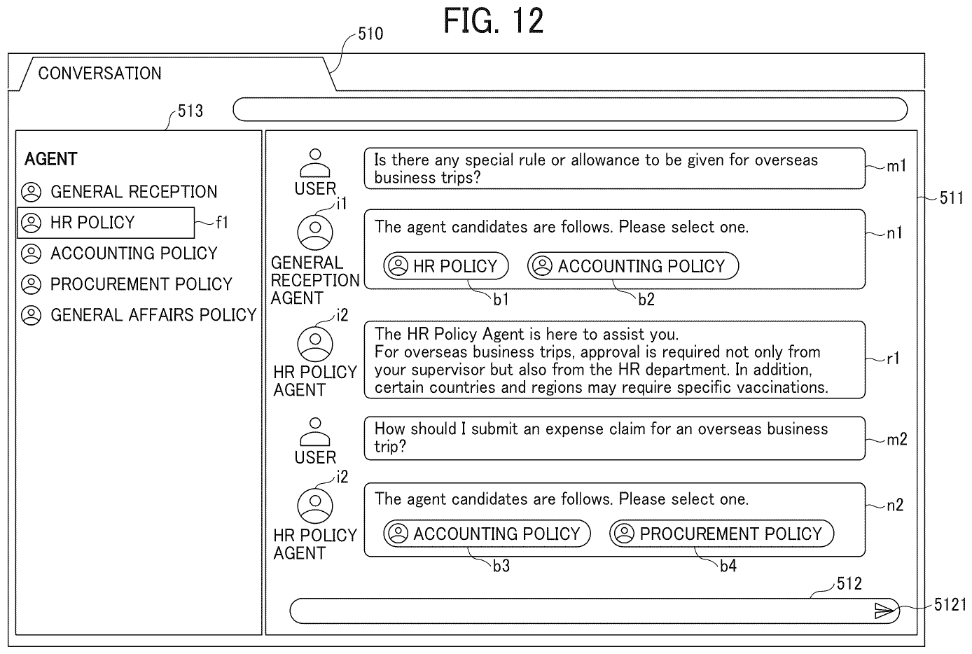

When the user inputs a new message in the message input area 512, the steps S111 to S119 of FIG. 4 are performed again with the new message being the subject message. As a result, the display content of the interactive screen 510 changes, for example, as illustrated in FIG. 12.

FIG. 12 is a diagram illustrating an example of an interactive screen displayed based on the determination result of the agent candidate for the second time or later in the first embodiment. In FIG. 12, the same elements as those in FIG. 11 are denoted by the same reference numerals, and descriptions thereof will be omitted. A message m2 and a notice n2 are added to the interactive screen 510 as illustrated in FIG. 12. The greeting sentence g1, which is displayed in FIG. 11, is not displayed as the window scrolls up. The message m2 is a message input by the user after the response r1. The notice n2 is a display content, which is added at S119 that is performed for the message m2. The notice n2 indicates that the agent candidates for the message m2 include the “accounting policy” agent and the “procurement policy” agent. The notice n2 further displays the button b3 for selecting the “accounting policy” agent, and the button b4 for selecting the “procurement policy” agent. When any of the buttons is selected, the operation proceeds to perform the step S120 and the subsequent steps of FIG. 4, and then the step S201 and the subsequent steps of FIG. 10.

At S117 of FIG. 4, there may an example case in which the agent candidate is not specified at all. Such example cases include, but not limited to, the case where the history information is not sufficiently accumulated, the case where there is no history information including a message whose similarity to the subject message exceeds a threshold, the case where there is no history information including attribute information whose similarity to the subject attribute information is equal to or greater than a certain value. In the present disclosure, the following two examples are illustrated.

In the first example, at S118, the determination unit 12 inputs a determination result indicating that there is no agent candidate to the display control unit 16. At S119, the display control unit 16 causes an interactive screen 510 to display a notification indicating that there is no agent capable of responding to the subject message. Specifically, the display control unit 16 generates display data based on the notification and transmits the display data to the terminal apparatus 20 for display of the notification. In this case, the process of step S120 and the subsequent steps of FIG. 4 and the steps of FIG. 10 are not performed. Therefore, the user needs to input the message again, while changing the expressions of the message.

In the second example, after the step S117, the steps S118 to S122 of FIG. 4 and the steps S201 and S202 of FIG. 10 are not performed, but the operation proceeds to perform the step S203 and the subsequent steps of FIG. 10. In this case, at S206, since the selected agent ID is not set so that the responding agent is not determined, the search unit 14 searches all the data storage units 123-1 to 102-N using the subject message vector to obtain the search result. At S208, in the case where the different system prompt is used for each agent, the AI control unit 15 generates a prompt by inputting the subject message and the search result of the search unit 14 to the system prompt to be used when the agent is not determined. The response generated by the AI 150 to which such a prompt is input is likely to have a quality lower than the quality of the response where the responding agent is determined. In the second example, however, the information processing apparatus 10 outputs some information to the user. The response is presented to the user as a response from the general reception agent.

As described above, according to the first embodiment, the information processing apparatus 10 specifies, as a responding agent, an agent that has responded to a message having a relatively high similarity to a message input from a user. Alternatively or additionally, the information processing apparatus 10 may specify, as a responding agent, an agent that has responded to a message from a user who has attribute information that is highly similar to the attribute information of a user who has input the message. In other words, the information processing apparatus 10 determines the interactive AI suitable for the message input from the user.

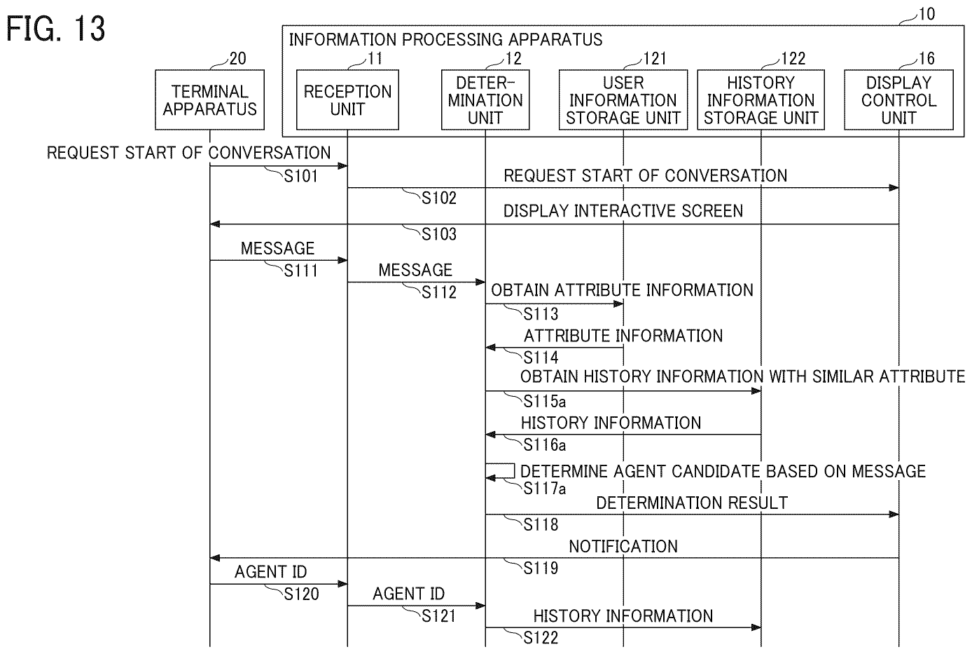

A second embodiment will be described below. In the second embodiment, differences from the first embodiment will be described. It is assumed that the second embodiment is similar to the first embodiment unless otherwise specified. In the second embodiment, the process of FIG. 4 is replaced with the process of FIG. 13.

FIG. 13 is a sequence diagram illustrating an example of a process to determine a responding agent according to the second embodiment. In FIG. 13, the same steps as those in FIG. 4 are denoted by the same step numerals, and descriptions thereof will be omitted. In FIG. 13, the steps S115, S116, and S117 of FIG. 4 are replaced with S115a, S116a, and S117a.

At S115a and S116a, the determination unit 12 acquires, from the history information storage unit 122, a part of history information (“extracted history information”) including attribution information having a relatively high similarity to the subject attribution information. The degree of similarity is evaluated in a substantially similar manner as described in the step S117 of the first embodiment.

At S117a, the determination unit 12 selects, as the agent candidate IDs, the agent IDs of one or more records of history information each including the message having a relatively high similarity to the subject message, from among the extracted history information. The degree of similarity is evaluated in a substantially similar manner as described in the steps S115 and S116 of the first embodiment.

The other configurations or processes are the same as those of the first embodiment.

As described above, in the second embodiment, the information processing apparatus 10 determines the interactive AI suitable for the message input from the user.

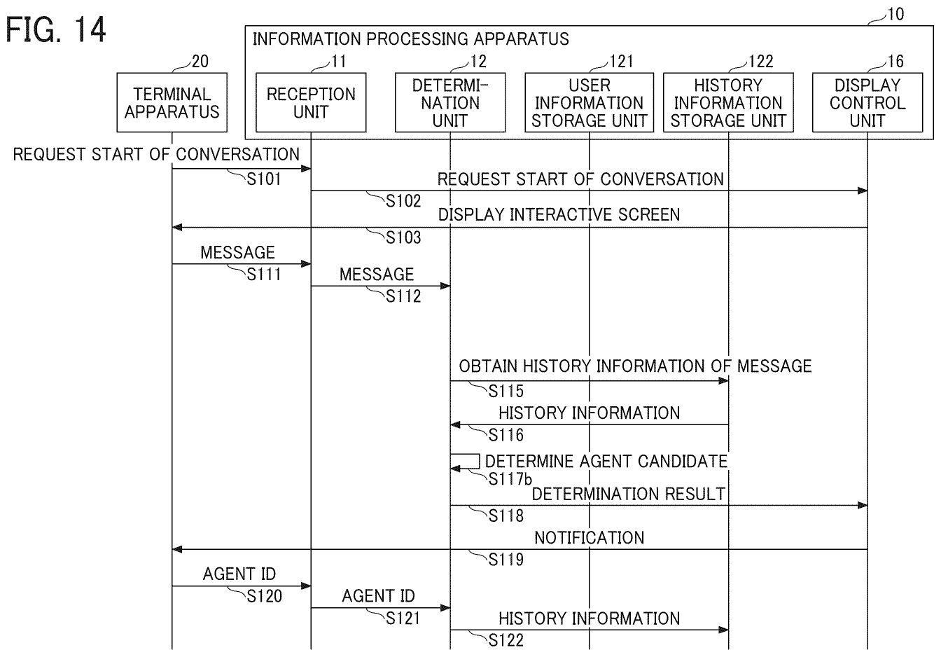

A third embodiment will be described below. In the third embodiment, differences from the first embodiment or the second embodiment will be described. It is assumed that the third embodiment is similar to the first embodiment or the second embodiment unless otherwise specified. In the third embodiment, the process of FIG. 4 or FIG. 13 is replaced with the process of FIG. 14.

FIG. 14 is a sequence diagram illustrating an example of a process to determine a responding agent according to the third embodiment. In FIG. 14, the same steps as those in FIG. 4 and FIG. 13 are denoted by the same step numerals, and descriptions thereof will be omitted.

As illustrated in FIG. 14, the step S117b is performed, in alternative to performing the steps S113 and S114 of FIG. 4. At S117b, the determination unit 12 selects, as the candidate agent IDs, the agent IDs of one or more records of the extracted history information acquired at steps S115 and S116. The determination unit 12 may select, from among the extracted history information, one or more records of history information including attribute information having a higher similarity to the subject attribute information, and specify the agent ID of each record of the selected history information as a candidate agent ID. After performing S117b, the steps S118 to S122 are performed in a substantially similar manner as illustrated in FIG. 4.

At S201 in FIG. 10, the agent ID of the selected responding agent is set in the search unit 14. After S201, the response generated by the responding agent is displayed on the interactive screen 510.

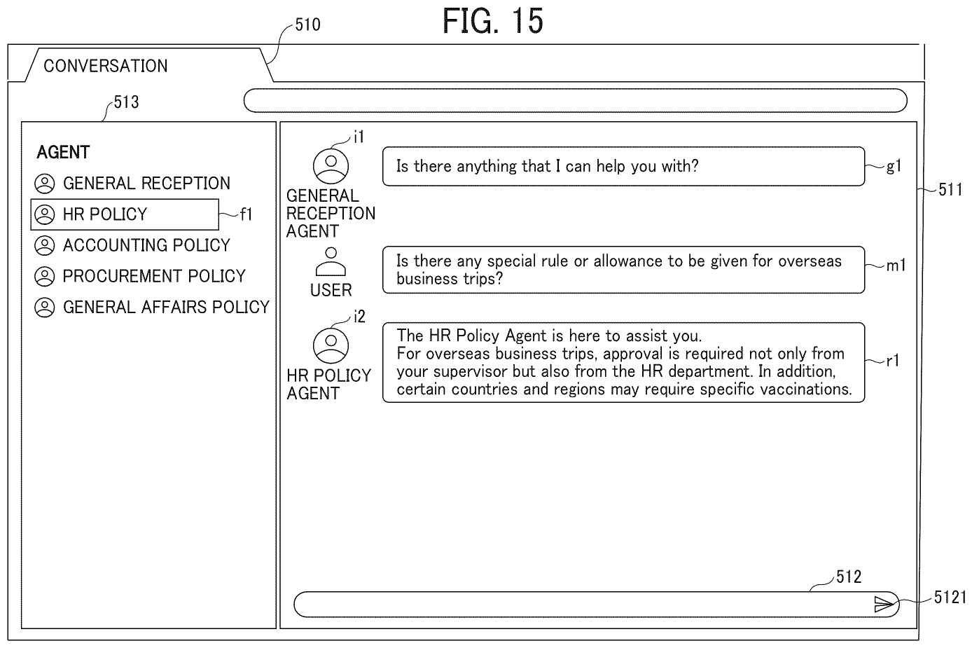

FIG. 15 is a diagram illustrating a modified example of an interactive screen that displays a response in any one of the first to third embodiments. In FIG. 15, the same elements as those in FIG. 11 are denoted by the same reference numerals, and descriptions thereof will be omitted. In the process of displaying the interactive screen of FIG. 15, the steps S118 to S122 of FIGS. 4, 13, or 14 are not performed.

In the process of displaying the interactive screen 510 of FIG. 15, in a case where multiple records of the extracted history information are determined to have the attribute information with the highest similarity to the subject attribute information, the determination unit 12 selects, as an agent candidate ID, the agent ID of one record of history information including a message having the highest similarity to the subject message, from among the multiple records of the extracted history information. In a case where there are multiple records of history information including a message having the highest similarity to the subject message among the multiple extracted history information, the determination unit 12 may select one of the records of history information at random or may select the one of the records of history information based on another selection criterion. In this case, the process of the steps S118 to S122 are not performed. The determination unit 12 sets the specified agent ID in the search unit 14 at S201. The interactive screen 510 of FIG. 15 does not include the notice n1, which is displayed at S119 as illustrated in FIG. 8.

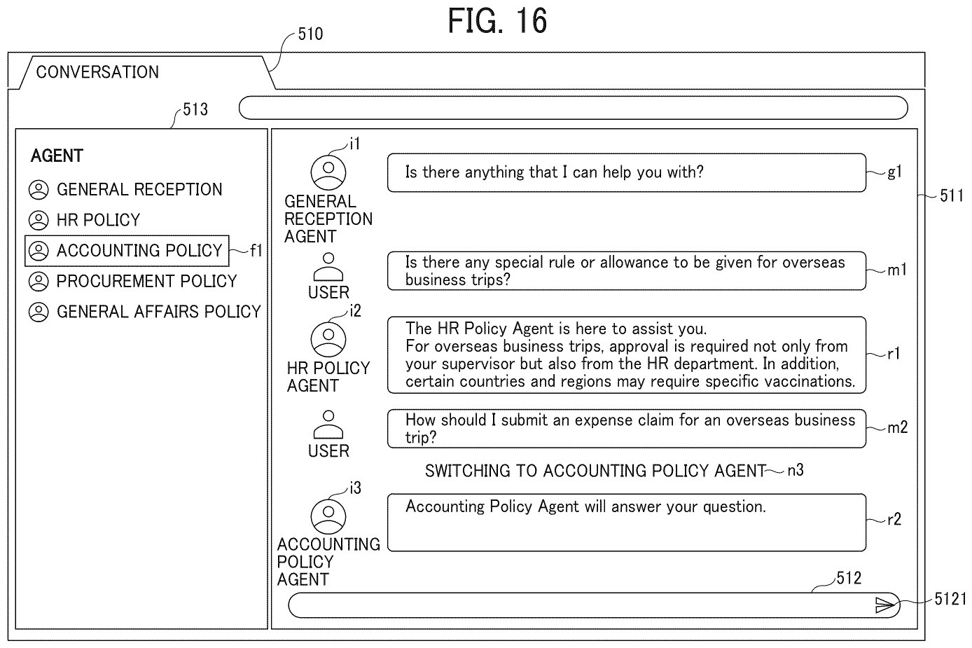

When the user inputs a new message in the message input area 512, the steps S111 to S117b of FIG. 14 are performed again with the input message being the subject message, and then the steps S201 to S212 of FIG. 10 are performed again. As a result, the display content of the interactive screen 510 changes, for example, as illustrated in FIG. 16.

FIG. 16 is a diagram illustrating an example of an interactive screen that displays a response for the second time or later, following the interactive screen of FIG. 15. In FIG. 16, the same elements as those in FIG. 12 and FIG. 15 are denoted by the same reference numerals, and descriptions thereof will be omitted.

In FIG. 16, a response r2 is displayed in response to the message m2. In this example, the responding agent that generates the response r2 is the “accounting policy” agent. In the case of switching the responding agent without allowing the user to select the responding agent, a notice n3 may be displayed, which includes a character string indicating the switching of the responding agent.

As described above, in the modified example of the first to third embodiments, the responding agent is automatically selected without the user performing the selection as in the screens of FIGS. 15 and 16. This reduces the burden on the user.

The information processing apparatus 10 may be any apparatus having a communication function, which may be implemented by communication circuitry. The information processing apparatus 10 may be, for example, an output device such as a projector (PJ), an interactive whiteboard (IWB; an electronic whiteboard having a blackboard function enabling mutual communication), or digital signage, or may be a head-up display (HUD), an industrial machine, an imaging device, a sound collecting device, a medical device, a networked home appliance, a laptop personal computer (PC), a mobile phone, a smartphone, a tablet terminal, a game console, a personal digital assistant (PDA), a digital camera, a wearable PC, or a desktop PC.

The functionality of the elements disclosed herein may be implemented using circuitry or processing circuitry which includes general purpose processors, special purpose processors, integrated circuits, application-specific integrated circuits (ASICs), field-programmable gate arrays (FPGAs), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a CD-ROM or DVD, and/or the memory of an FPGA or ASIC.

The illustrated apparatuses or devices are only illustrative of one of several computing environments for implementing the one or more embodiments disclosed herein.

In some embodiments, the information processing apparatus 10 includes multiple computing devices, such as a server cluster. The multiple computing devices are configured to communicate with one another through any type of communication link, including a network, a shared memory, etc., to collectively perform the processes disclosed herein. The terminal apparatus 20 may also include multiple computing devices configured to communicate with one another.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

The following non-limiting examples illustrate aspects of the present disclosure.

### Aspect 1

An information processing system that functions as a plurality of interactive AIs that interact with a user, includes: a reception unit that receives an input of a first message from the user; a determination unit that refers to a storage unit that stores, for each of one or more messages previously received, the message and information for identifying the interactive AI that has responded to the message in association, to determine an interactive AI configured to respond to the first message from among the plurality of interactive AIs based on a relevance between the messages previously received and the first message; and a display control unit that displays a response generated by the interactive AI that is determined in response to the first message.

### Aspect 2

In the information processing system according to Aspect 1, the determination unit determines one or more interactive AIs each configured to respond to the first message based on a similarity indicating the relevance between the first message and each of the one or more messages stored in the storage unit.

### Aspect 3

In the information processing apparatus according to Aspect 1 or Aspect 2, the display control unit displays information indicating the one or more interactive AIs for selection by the user, and displays the response generated by the interactive AI selected by the user.

### Aspect 4

In the information processing system according to any one of Aspect 1 to Aspect 3, the storage unit further stores attribute information of a user who has input the message previously received. The determination unit determines the interactive AI configured to respond to the first message based on a similarity between attribute information of the user who has input the first message and the attribute information stored in the storage unit.

### Aspect 5

An information processing apparatus that functions as a plurality of interactive AIs that interact with a user, includes: a reception unit that receives an input of a first message from the user; a determination unit that refers to a storage unit that stores, for each of one or more messages previously received, the message and information for identifying the interactive AI that has responded to the message in association, to determine an interactive AI configured to respond to the first message from among the plurality of interactive AIs based on a relevance between the messages previously received and the first message; and a display control unit that displays a response generated by the interactive AI that is determined in response to the first message.

### Aspect 6

An information processing method, performed by an information processing apparatus that functions as a plurality of interactive AIs that interact with a user, includes: receiving an input of a first message from the user; referring to a storage unit that stores, for each of one or more messages previously received, the message and information for identifying the interactive AI that has responded to the message in association, to determine an interactive AI configured to respond to the first message from among the plurality of interactive AIs based on a relevance between the messages previously received and the first message; and displaying a response generated by the interactive AI in response to the first message.

### Aspect 7

A non-transitory recording medium stores a computer program that causes an information processing apparatus that functions as a plurality of interactive AIs that interact with a user, to perform a method including: receiving an input of a first message from the user; referring to a storage unit that stores, for each of one or more messages previously received, the message and information for identifying the interactive AI that has responded to the message in association, to determine an interactive AI configured to respond to the first message from among the plurality of interactive AIs based on a relevance between the messages previously received and the first message; and displaying a response generated by the interactive AI in response to the first message.

1. An information processing system, comprising:
circuitry configured to activate one or more interactive artificial intelligences (AIs) that interact with a user; and
a memory that stores, for each of one or more messages previously received, the message and information for identifying the interactive AI that has responded to the message in association;
wherein the circuitry is further configured to:
receive an input of a first message from the user;
determine an interactive AI configured to respond to the first message based on a relevance between the first message and the one or more messages stored in the memory; and
display, on a display, a response generated by the interactive AI that is determined in response to the first message.

2. The information processing system according to claim 1, wherein
the circuitry is configured to determine, as the interactive AI configured to respond, one or more interactive AIs based on a similarity between the first message and each of the one or more messages stored in the memory.

3. The information processing system according to claim 2, wherein
the one or more interactive AIs are each an interactive AI that has responded to the message that is similar to the first message.

4. The information processing system according to claim 1, wherein, in a case where the interactive AI that is determined includes two or more interactive AIs,
the circuitry is configured to display information indicating the two or more interactive AIs for selection by the user, and display the response generated by an interactive AI selected by the user.

5. The information processing system according to claim 4, wherein
the circuitry is configured to display a screen that allows the user to transmit a new message to the interactive AI selected by the user.

6. The information processing system according to claim 1, wherein
the memory further stores, for each of the one or more messages previously received, attribute information of a user who has input the message previously received, and
the circuitry determines the interactive AI configured to respond to the first message based on a similarity between attribute information of the user who has input the first message and the attribute information stored in the memory.

7. An information processing apparatus configured to activate one or more interactive AIs that interact with a user, the information processing apparatus comprising
circuitry configured to:
receive an input of a first message from the user;
determine an interactive AI configured to respond to the first message based on a relevance between the first message and one or more messages stored in a memory, the memory storing, for each of the one or more messages previously received, the message and information for identifying the interactive AI that has responded to the message in association; and
display, on a display, a response generated by the interactive AI that is determined in response to the first message.

8. An information processing method performed by one or more processors that active one or more interactive AIs that interact with a user, the information processing method comprising:
receiving an input of a first message from the user;
determining an interactive AI configured to respond to the first message based on a relevance between the first message and one or more messages stored in a memory, the memory storing, for each of the one or more messages previously received, the message and information for identifying the interactive AI that has responded to the message in association; and
displaying, on a display, a response generated by the interactive AI that is determined in response to the first message.
